(19) United States
(12) Patent Application Publication
(10) Pub. No.: US 2006/0273898 A1
(43) Pub. Date: Dec. 7, 2006

(54) Damage detecting apparatus

(75) Inventor: Minoru Hagiwara, Tokyo (JP)

Correspondence Address: KANESAKA BERNER AND PARTNERS LLP, SUITE 300, 1700 DIAGONAL RD, ALEXANDRIA, VA, 22314-2848, US

(73) Assignee: TAISEI LAMINATER CO., LTD.

(21) Appl. No.: 11/434,122

(22) Filed: May 16, 2006

(30) Foreign Application Priority Data
Jun. 3, 2005 (JP) 2005-164879
Nov. 7, 2005 (JP) 2005-322947

(51) Int. Cl. G08B 13/08

(52) U.S. Cl. 340/545.4; 340/539.1

(57) ABSTRACT

An aim of this invention is to detect an unusual state when a thief or burglar breaks the glass plate of a glass window to attempt to enter a building, and to issue an alarm or make it possible to notify a security company.

According to one aspect of this invention, a conductive pattern 50 of predetermined shape is formed by a conductive thin layer on the surface of a glass plate 47 of a window glass 45, and a detector 51 is connected to the split or cut positions of this conductive pattern 50. If the glass plate 47 is broken so that the conductive pattern 50 open, the detector 51 detects the open circuit of the conductive pattern, the detector 51 issues an alarm, transmits a damage detection signal to a relay 74 by radio, and transmits the damage detection signal from this relay 74 to a central monitoring unit 84.

### BACKGROUND OF THE INVENTION

1. Field of the Invention

The present invention relates to a damage detecting apparatus, and in particular, to a damage detecting apparatus which detects damage in the event of breakage of a glass plate.

2. Description of the Related Art

Now that the security of houses, offices and other buildings is being increasingly compromised, the maintenance of security is an important issue. In particular, if a thief or burglar breaks into a residence where people are living from a door or window, the life of the residents is disrupted, and in some cases, valuables may be taken or the occupants may be physically harmed.

It was therefore common to install an anti-theft apparatus in a part of a door or a window. If a thief attempted to enter the building from outside, theft and burglary were prevented by issuing an alarm or notifying a security company.

In an ordinary anti-theft apparatus, a magnet is fixed to a movable part which moves when a door or glass window is opened or closed. A non-contact proximity switch is formed in door frame or window frame, and if the door or window is wrenched open, this magnet separates and the proximity switch operates. This activates a detection circuit, operates an alarm device and transmits a damage detection signal to a security company.

The disadvantage of this prior art anti-theft apparatus is that if a burglar breaks or cuts the glass of a glass window or glass door consisting mainly of a glass plate so as to make an opening of predetermined size, and then enters the building through this opening, this non-contact detection switch does not function. Therefore, an alarm device does not function, and no report is made to the security company. Such a prior art anti-theft apparatus is defenseless against theft where the burglar enters by breaking the glass plate.

### OBJECTS AND SUMMARY OF THE INVENTION

It is therefore an object of the present invention to provide a damage detecting apparatus which detects and reports damage when the glass plate of a glass window or a glass door is broken or cut.

It is another object of the invention to provide a damage detecting apparatus which detects damage by open circuit of a conductive pattern provided in a glass plate when the glass plate of a glass window or a glass door is broken or cut.

It is a further object of the present invention to provide a damage detecting apparatus which can prevent theft by a film for reinforcing a glass plate.

It is a still further object of the invention to provide a damage detecting apparatus which can prevent theft without loss of transparency, and without interfering with transmission of light.

It is a still further object of the invention to provide a damage detecting apparatus which can be easily installed, and which requires no special construction.

It is a still further object of the invention to provide a damage detecting apparatus which does not interfere with an open-close action and does not malfunction due to the open-close action when applied to a glass window.

It is a still further object of the invention to provide a damage detecting apparatus which does not require battery replacement, and does not require an external power source.

The aforesaid objects and other objects of the invention will become apparent from the technical concept of the present invention and embodiments thereof as described hereinafter.

An aspect of the present invention relates to a damage detecting apparatus wherein a transparent or translucent film, on which a transparent or translucent conductive pattern is formed, is stuck on a glass plate of a glass window or a glass door, the conductive pattern is connected to a detection circuit, and the circuit is activated if the glass plate is damaged and the conductive pattern is broken. Here, the film for theft prevention may serve also as a reinforcement of the glass plate. The conductive pattern may be a transparent conductive film or layer. The conductive pattern may be made of indium oxide (In₂O₃, ITO), tin oxide (SnO₂) or zinc oxide (ZnO). The conductive pattern may be connected to a terminal in the vicinity of a frame. The film may also be stuck to the glass plate so that the conductive pattern is in contact with the surface of the glass plate.

Another aspect of the present invention relates to a damage detecting apparatus comprising a transparent or translucent conductive pattern formed on the surface of a glass plate, and a detector comprising an electrode connected to the conductive pattern which detects an open circuit of the conductive pattern in the event of breakage of the glass plate. The conductive pattern may be formed directly on the surface of the glass plate. Alternatively, the conductive pattern may be formed on the surface of a film fixed to the glass plate which is arranged to be in contact with the surface thereof. The conductive pattern may be a transparent conductive layer.

The detector is preferably fixed to the surface of the glass plate, the dimensions of the detector in the thickness direction of the glass plate preferably being smaller than the protrusion amount of the frame from the surface of the glass plate fixed to the frame. The detector may have a radio transmitting means, so that when an open circuit of the conductive pattern is detected, a damage detection signal can be transmitted by radio. It may also be provided a intermediate transmitting device or an alarm device which receives the damage detection signal from the detector by radio. The transmitting or alarm device may transmit the damage detection signal to another control unit, or may perform an alarm action. The drive source of the detector may be a solar battery, power being generated by the light which enters through the glass plate.

A still another aspect of the present invention relates to a damage detecting apparatus comprising a conductive pattern of predetermined shape formed on the surface of a glass plate, and a detector comprising an electrode connected to the conductive pattern which detects an open circuit of the conductive pattern in the event of breakage of the glass plate.

Here, the conductive pattern is opaque, and may be disposed on the edge of the glass plate so that it can be hidden by the frame holding the glass plate. Alternatively, the conductive pattern may be an opaque metal film, a conductive film containing a conductive powder, a metal foil or a carbon graphite sheet. The conductive pattern may also serve as a heat-generating means which warms the glass plate by Joule heat on passing a current.

According to an aspect of this invention, there is provided an apparatus comprising a transparent or translucent film on which a transparent or translucent conductive pattern is formed, the film being fixed to a glass plate such as a glass window or glass door, and the conductive pattern being connected to a detection circuit. If the glass plate is broken and the conductive pattern is broken, the detection circuit is activated.

In this damage detecting apparatus, if a thief or burglar breaks or cuts the glass plate such as a glass window or glass door to form an opening in order to enter the building, when the glass plate is broken or cut, the conductive pattern on the film fixed to this glass plate is also broken. This break is detected by the detection circuit which is activated thereby, hence theft can be definitively prevented.

According to another aspect of this invention, there is provided an apparatus comprising a transparent or translucent conductive pattern formed on the surface of a glass plate, and a detector comprising a electrode to which the conductive pattern is connected which detects a break in the conductive pattern in the event of breakage of the glass plate.

In this damage detecting apparatus, if the glass plate is broken for some reason, the conductive pattern formed on the surface is also broken. The break in the conductive pattern is detected by the detector, and a damage detection signal is then output.

Here, the conductive pattern is formed on the surface of the glass plate directly, and if the conductive pattern is broken when the glass plate is broken or cut, the break in the conductive pattern is detected by the detector.

When the conductive pattern is formed on the surface of a film fixed to the glass plate which is in contact with the surface thereof, the conductive pattern on the surface of the film fixed to the glass plate breaks, and this damage is detected by a detector. In this case, the glass plate is reinforced by the film, so glass fragments are prevented from scattering even in the event of a breakage.

The above and other objects, features and advantages of this invention will be apparent from the following description of illustrative embodiments, which are to be read in connection with accompanying drawings.

### BRIEF DESCRIPTION OF THE DRAWINGS

FIG. 1 is a plan view of a substrate, on which a transparent metal thin film is formed, of the first embodiment.

FIG. 2 is a plan view of a substrate coated with a mold release solvent.

FIG. 3 is a plan view of a substrate to which a transparent polymer film is fixed.

FIG. 4 is a perspective view of essential parts showing a state where the transparent polymer film is peeled away from the substrate.

FIG. 5 is a front view of a window glass to which the transparent polymer film is fixed.

FIG. 6 is an enlarged longitudinal cross-sectional view of a glass plate to which the transparent polymer film is fixed.

FIG. 7 is a block diagram of a detection circuit system forming an anti-theft apparatus.

FIG. 8 is a plan view of the transparent polymer film showing a transparent conductive pattern according to a modification.

FIG. 9 Is a plan view of the transparent polymer film showing a transparent conductive pattern according to another modification.

FIG. 10 is a plan view showing a transparent conductive pattern according to yet another modification.

FIG. 11 is a circuit diagram of an anti-theft circuit according to a modification.

FIG. 12 is a circuit diagram of an anti-theft circuit according to yet another modification.

FIG. 13 is a front view of a glass window fitted with a damage detecting apparatus, according to the second embodiment.

FIG. 14 is a plan view of a base film for forming a conductive pattern.

FIG. 15 is a plan view of a base film coated with a mold release solvent.

FIG. 16 is a perspective view of essential parts showing a transfer operation by a heating roller.

FIG. 17 is a perspective view of essential parts showing a peeling/transfer operation of a conductive thin film.

FIG. 18 is a perspective view of essential parts showing the fitting of a detector to a glass plate.

FIG. 19 is a perspective view of the rear surface of the detector.

FIG. 20 is a transverse cross-sectional view showing the fitting of the detector to the glass plate.

FIG. 21 is a block diagram and circuit diagram showing the circuit construction of the detector.

FIG. 22 is a block diagram of a security system using the damage detecting apparatus in a building.

FIG. 23 is a block diagram showing the circuit construction of a relay and a central monitoring unit.

FIG. 24 is a perspective view of the essential parts of a damage detecting apparatus wherein a conductive pattern is formed on a reinforcing film side.

FIG. 25 is a front view of a glass plate to which the reinforcing film is fixed.

FIG. 26 is an enlarged front view of essential parts showing how the detector on the glass plate is connected to the conductive pattern.

FIG. 27 is a longitudinal cross-sectional view showing a state wherein a spring contact fixed to the detector is connected to a copper foil.

FIG. 28 is a perspective view of the essential parts of a detector having a solar cell as drive source.

FIG. 29 is a plan view of a glass window having a zigzag conductive pattern.

FIG. 30 is a front view of a glass window on which an opaque conductive pattern is formed in an edge part of a glass plate.

FIG. 31 is a perspective view of essential parts of the opaque conductive pattern.

FIG. 32 is a front view of a damage detecting apparatus which also has the function of preventing condensation and fogging.

### DESCRIPTION OF THE PREFERRED EMBODIMENTS

### Embodiment 1

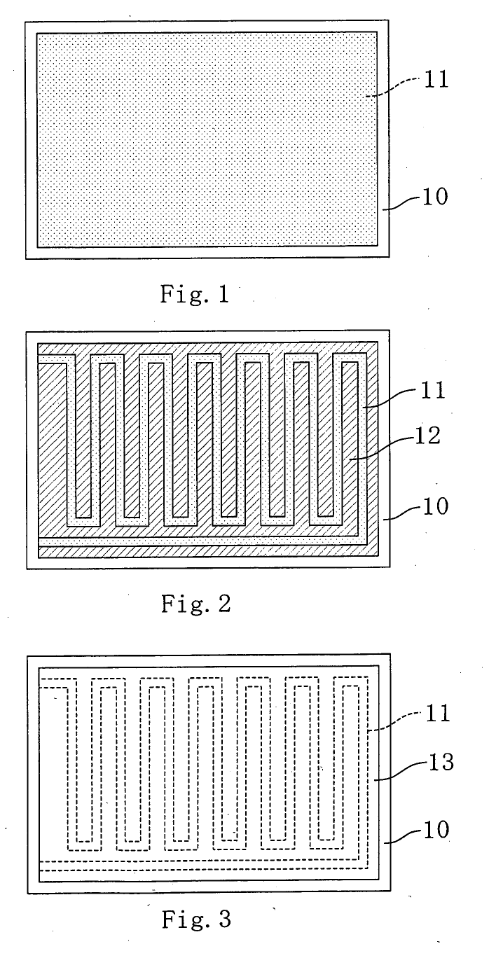

The present invention will now be described in more detail by specific embodiments referring to the drawings. First, referring to FIG. 1-FIG. 4, a method of manufacturing an anti-theft film comprising a conductive pattern will be described. As shown in FIG. 1, a substrate 10 having a predetermined shape and dimensions is prepared. The substrate 10 is a plate-shaped body made of a suitable material such as a synthetic resin, metal or ceramics. The substrate 10 must have a flat, smooth surface. A conductive film 11 is formed on the surface of this substrate 10. The conductive film 11 may be a transparent metal film of indium oxide (In₂O₃, ITO), tin oxide (SnO₂) or zinc oxide (ZnO). The metal thin film 11 is generally formed by chemical vapor deposition, but may be formed alternatively by any method for forming thin films known in the art, such as for example plasma CVD or sputtering.

After forming this thin film 11, as shown in FIG. 2, a mold release solvent 12 is coated on the surface excepting the part where the conductive pattern is to be formed. The mold release solvent 12 may be for example a mold release ink, silicone solution or screen printing ink which does not stick to polymer films. The aforesaid mold release solvent is then made to stick to the surface of the thin film 11 by a method such as printing or the like, leaving the part corresponding to the conductive pattern. The mold release solvent 12 is then dried.

Subsequently, as shown in FIG. 3, a transparent polymer film 13 which functions also as a reinforcement for the glass plate is fixed to the surface of the substrate 10. If high transparency is required, the transparent polymer film 13 is selected from a material such as an acrylic resin, polycarbonate resin or vinyl chloride resin. If a high degree of transparency is not required, a polyester resin or a polyolefin resin such as a polyethylene can be used. The thickness of the film lies within the range of 50-300 μm. An emulsion of a synthetic resin which sticks to metal relatively easily, such as for example polyethylene, hot melt, nylon or polyester, is also first coated on the resin surface to enhance contact with the transparent metal thin film 11.

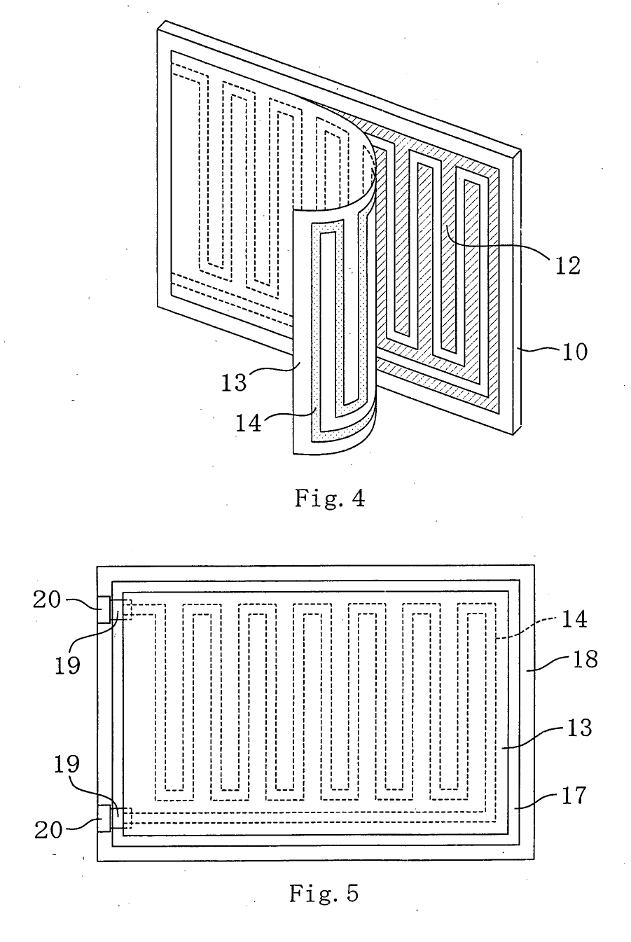

The transparent polymer film 13 is then laid over on the thin film 11, and pressurized while heating to a temperature within the range of 50-300 □ suited to the polymer film 13. Due to the synthetic resin emulsion coated on the surface of this polymer film 13, the transparent metal thin film 11 in the area not coated by the mold release solvent 12 is transferred to the surface of the transparent polymer film 13. As shown in FIG. 4, the transparent polymer film 13 is then gently released from the surface of the substrate 10. The part of the transparent metal thin film 11 not coated with the mold release solvent 12 is thereby transferred to the surface of the transparent polymer film 13, and a transparent conductive pattern 14 is thus formed on the surface of the transparent polymer film 13. In other words, by this heating method, the transparent metal thin film 11 which is pre-formed in the surface of the substrate 10 is selectively transferred to the transparent polymer film 13 so as to form the transparent conductive pattern 14.

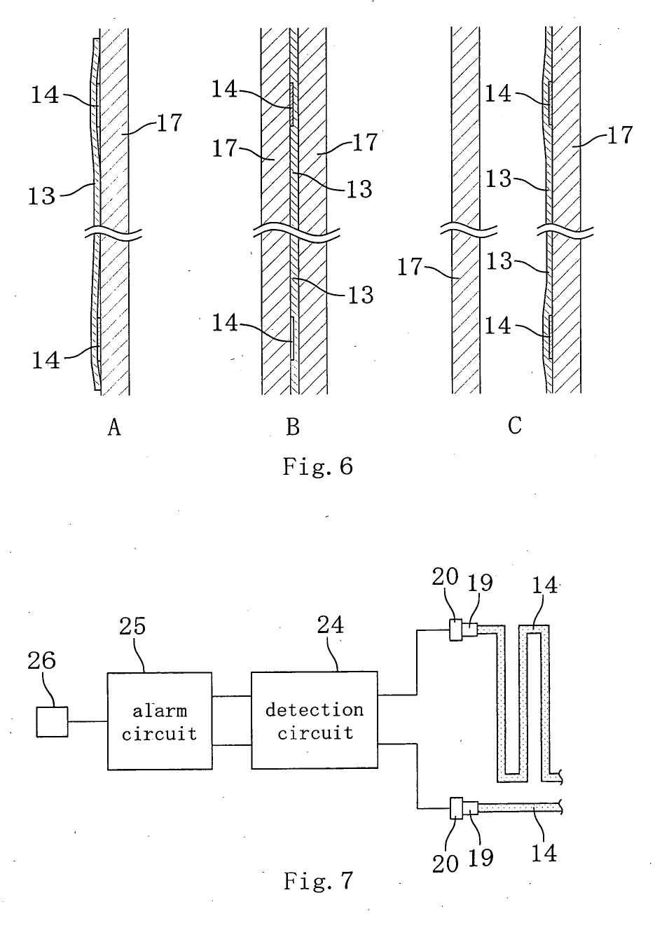

Next, describing now the construction of the anti-theft apparatus using this transparent polymer film 13, as shown in FIG. 5, the transparent polymer film 13 on which the transparent conductive pattern 14 has been formed is fixed to the surface of a glass plate 17, the edge of the window glass 17 being supported by a frame 18. The transparent polymer film 13 is fixed so that it effectively covers the window glass 17. As shown in FIG. 6A, the transparent conductive pattern 14 is sandwiched between the film 13 and the glass plate 17, thereby insulating the conductive pattern 14. The terminal part of the conductive pattern 14 is connected to a terminal 19. The terminal 19 is a copper foil or thin copper plate, and is supported at a predetermined position of the window frame 18. A connector 20 attached to the frame 18 is connected to this terminal 19.

As shown in FIG. 6B, the transparent polymer film 13 may also be sandwiched between two glass plates 17. Alternatively, as shown in FIG. 6C, it may be stuck to the inside surface of one of the glass plates 17 which constitute a pair glass. When the pair of glass plates 17 are window glass, the polymer film 13 is fixed to the surface of one of the window glasses 17 so that it is within a sealed enclosure.

Next, referring to FIG. 7, the detection circuit will be described. The conductive pattern 14 on the glass plate 17, as shown in FIG. 7, is connected to a detection circuit 24 via the terminal 19 and connector 20. The detection circuit 24 is further connected to an alarm circuit 25. The alarm circuit 25 is connected to an alarm device 26.

According to this construction, if for example the glass plate 17 is broken, or an opening in the glass is formed by a special blade such as a glass cutter, at least part of the conductive pattern 14 on the surface of the transparent polymer film 13 stuck to the surface of the window glass 17 will be broken. Therefore, the conductive pattern 14 shown in FIG. 7 will go from closed circuit to open circuit. This situation is detected by the detection circuit 24. If the detection circuit 24 detects a break in the conductive pattern 14, the alarm circuit 25 drives the alarm device 26. Hence, the break in the window glass 17 is detected, the alarm device is activated and the entry of a thief or burglar can be notified to the authorities.

The anti-theft film 13 of this embodiment and the anti-theft apparatus using this anti-theft film 13 do not use any magnet fixed to the frame 18 of the window glass 17, wherein a break is detected by a non-contact detection switch, but instead detects a break in the conductive pattern 14 of the transparent polymer film 13 fixed to the window glass 17. Therefore, if the window glass 17 is closed, the glass plate of the window glass 17 is broken to form an opening large enough for a person to enter and a burglar attempts to enter the building, this fact can be detected without fail. Therefore, the entry of a burglar from outside due to breakage or damage of the glass plate, which could not be avoided in the prior art, can now be prevented.

The transparent polymer film 13 on which the conductive pattern 14 is formed also functions as a reinforcing film. Specifically, it functions as a reinforcing film which prevents breakage of the window glass 17. If the glass should break, it also functions to the prevent scattering of glass fragments. Therefore, the glass itself is reinforced by the polymer film 13, and scattering is prevented in the event of a breakage. Hence, reinforcement and theft prevention can be achieved concurrently without any major increase of cost.

By adding impurities to the composition of the conductive pattern 14, a resistance can be imparted to the conductive pattern 14. In this case, when a current is passed through the conductive pattern 14, the transparent polymer film generates heat. The temperature of the window glass 17 rises due to this heat, which prevents condensation of the water. Also, if the conductive pattern 14 is formed densely and is disposed in a vertical or horizontal direction, it can block horizontally polarized or vertically polarized radio waves, in which case the transparent polymer film 13 comprising the conductive pattern 14 functions as an electromagnetic shield.

The method of forming the transparent conductive pattern 14 on the surface of the transparent polymer film 13 is not limited to the aforesaid heating transfer method, and various other techniques may be used. For example, the conductive pattern 14 may be formed directly on the polymer film 13 by screen printing or the like. Alternatively, a mask may be laid on the surface of the transparent polymer film 13, and the transparent conductive pattern formed directly using a thin film-forming method. In this case, the transparent conductive pattern can be formed on the transparent polymer film 13 by sputtering or the like. Alternatively, the transparent conductive pattern may be formed by screen printing with a conductive ink.

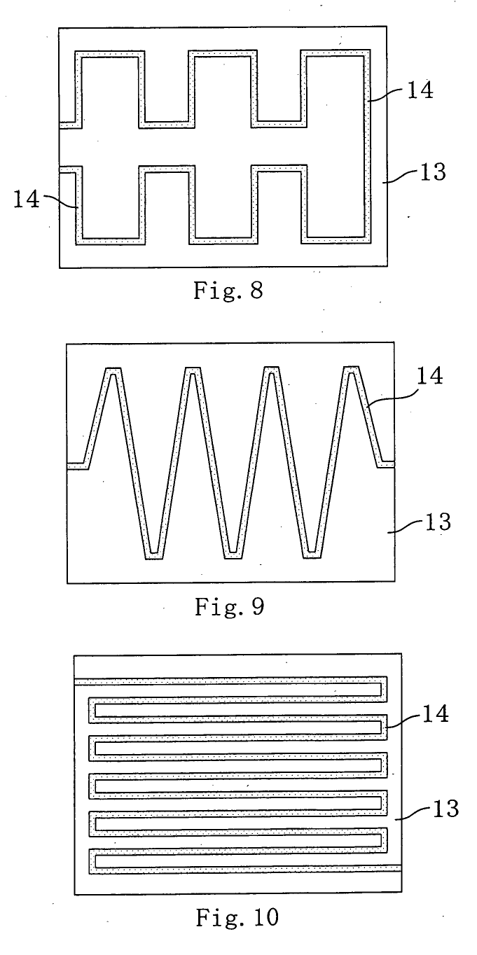

The shape of the transparent conductive pattern 14 formed on the transparent polymer film 13 fixed to the window glass 17 having the dual function of a reinforcement, is not necessarily limited to the aforesaid embodiments, various modifications being possible as shown in FIG. 8, FIG. 9 and FIG. 10. In fact, any pattern can be used provided that, in the event of an opening large enough for a person to enter or a hand to be inserted being formed in the glass, part of the conductive pattern 14 will break without fail and a break state will occur.

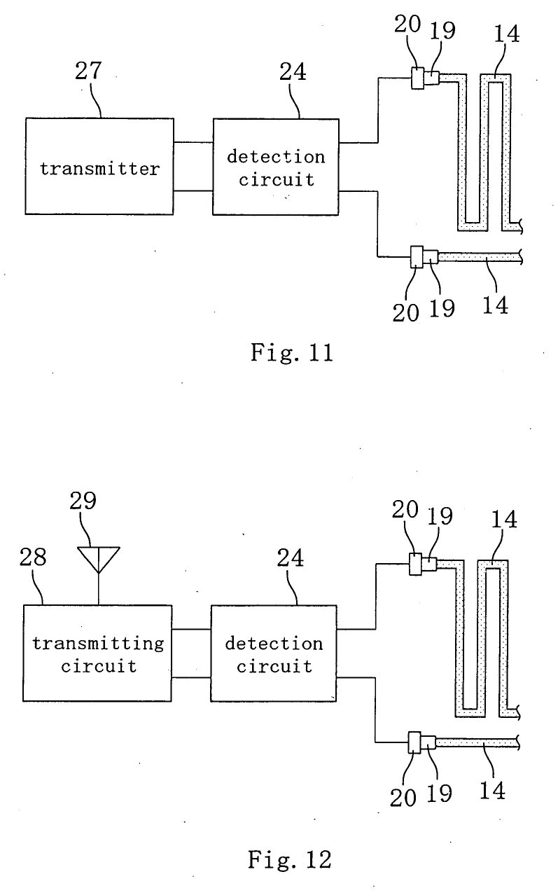

The circuit block of the anti-theft apparatus is not necessarily limited to that shown in FIG. 7. For example, as shown in FIG. 11, instead of the alarm circuit 25, a transmitter 27 may be connected to the detection circuit 24, and a damage detection signal sent immediately by this transmitter 27 to a security company. In this case, the security company which has received the damage detection signal can act immediately, determine the cause of the damage and take appropriate measures.

FIG. 12 shows yet another modification. Here, a transmitting circuit 28 connected to the detection circuit 24 is a radio transmitting circuit, so that an alarm signal can be transmitted to the outside from an antenna 29 by radio. According to this construction, it is not necessary to connect a signal transmission cable to the anti-theft apparatus, which makes it easier to install the apparatus.

The modification shown in FIG. 12 is suitable for application as an anti-theft apparatus for a vehicle. In this case, it may be used as a car anti-theft apparatus by, for example, fixing the transparent polymer film 13 on which the transparent conductive pattern 14 is formed, to the window glass of the door on one side of the driver's seat or the adjacent passenger seat. Moreover, if the window glass is broken, an alarm signal can be sent from the antenna 29 by radio, which is useful as a car theft alarm transmitter when the car is parked.

### Embodiment 2

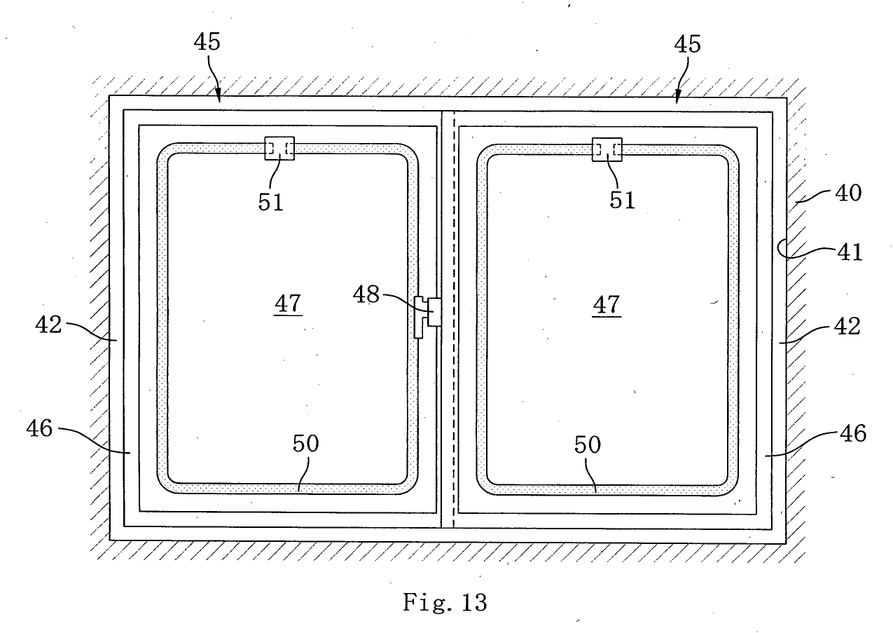

Next, another embodiment will be described. FIG. 13 shows the window part of a building fitted with a damage detecting apparatus according to a second embodiment. An oblong rectangular opening 41 is formed at a predetermined position in a side wall 40 of the building. A frame 42, which may for example be a sash, is fixed to the perimeter of this opening 41.

Glass windows 45 are fitted to the part of the opening 41 to which the frame 42 is fixed. Here, two glass windows 45 which open in mutually opposite directions are fitted. Both of the windows 45 have a frame 46, this frame 46 being slidably supported on a rail in the opening frame 42. A glass plate 47 is also fixed in the frame 46. The two glass windows 45 are locked by a locking device 48 at an intersection position, and are thereby secured.

The particular feature of this window glass 45 is a conductive pattern 50 formed on the surface of the glass plate 47 forming the glass window 45. The conductive pattern 50 is continuously formed along the inside of the window frames 46, and split approximately in the middle of the upper side. Detectors 51 for performing damage detection are fixed so that they straddle the split of the conductive pattern 50, any break in the conductive pattern 50 due to damage being detected by these detectors 51.

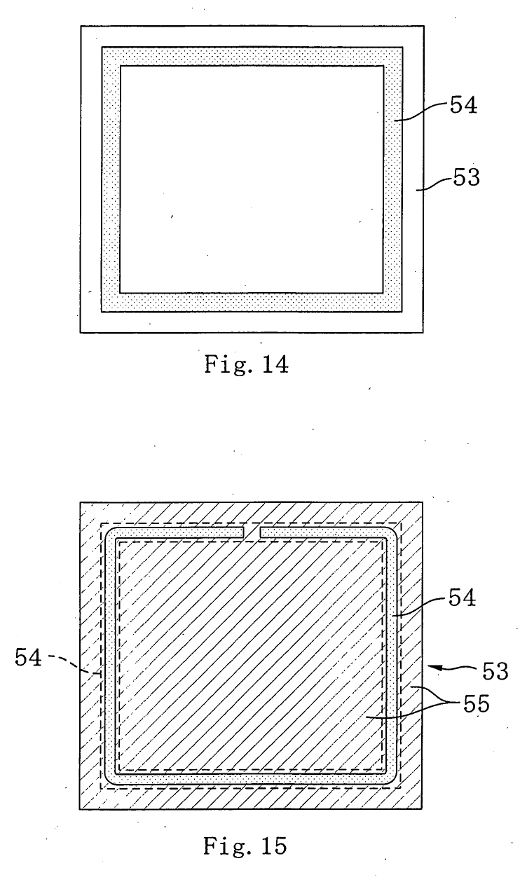

Next, the operation will be described when the conductive pattern 50 is formed in the glass plate 47 of the glass window 45. As shown in FIG. 14, a base film 53 which is substantially rectangular and slightly smaller than the glass plate 47 is provided. The base film 53 may for example be a synthetic resin films such as polyester. A conductive thin film 54 is formed on the surface of this base film 53. The conductive thin film 54 is a transparent metal thin film 54 of indium oxide (In₂O₃, ITO), tin oxide (SnO₂) or zinc oxide (ZnO). The metal thin film 54 is generally formed by chemical vapor deposition, but may be formed by any desired thin film-forming method known in the art such as for example plasma CVD or sputtering. The conductive thin film 54 may be formed over the entire surface of the base film 53, but in this case, since the consumption amount of conductive thin film-forming material increases, it is preferably formed to be slightly wider than the width thereof only at a position corresponding to the conductive pattern 50 which is desired to form.

After forming this conductive thin film 54, as shown in FIG. 15, a mold release solvent 55 is coated on its surface except for the part where the conductive pattern 50 is to be formed. The mold release solvent 55 may be for example a mold release ink, silicone solution or screen printing ink which does not stick to the glass plate 47. The mold release solvent 55 is then made to adhere to the surface of the conductive thin film 54 by a method such as printing or the like except for the part corresponding to the conductive pattern 50.

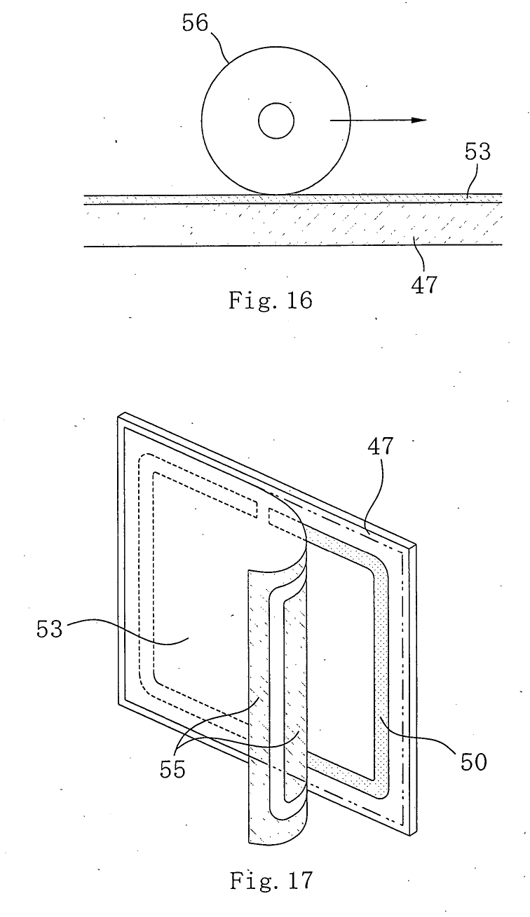

Subsequently, as shown in FIG. 16, the base film 53 is fixed to the surface of the glass plate 47. The conductive thin film 54 and surface coated with the mold release solvent 55 are disposed in contact with the glass plate 47. It is also preferable to first coat an emulsion of a synthetic resin which sticks to metal relatively easily such as polyethylene, hot melt, nylon or polyester on the surface on the fixing side of the base film 53, so as to enhance contact properties when the conductive thin film 54 is transferred.

Once the base film 53 is laid on the glass plate 47, a heating roller 56 is pressed against the base film 53, and the glass plate 47 is thereby pressurized while heating the base film 53 to a suitable temperature within the range of 50-300° C. Due to the synthetic resin emulsion coated on the surface of this base film 53, the conductive thin film 54 in the area not coated by the mold release solvent 55 is transferred to the surface of the glass plate 47. As shown in FIG. 17, the base film 53 is then gently peeled away from the surface of the glass plate 47. The conductive thin film 54 in the part not coated by the mold release solvent 55 is thereby peeled off the surface of the base film 53 and transferred to the glass plate 47, thus obtaining the glass plate 47 comprising the conductive pattern 50 of predetermined shape on its surface. In other words, by the heat transfer method, the conductive thin film 54 which was pre-formed on the base film 53 is selectively transferred to the glass plate 47 so as to form the transparent conductive pattern 50. The method of forming the conductive pattern 50 on the glass plate 47 is not however necessarily limited to the above peel and transfer method, and may be any desired method selected from among other thin film-forming methods.

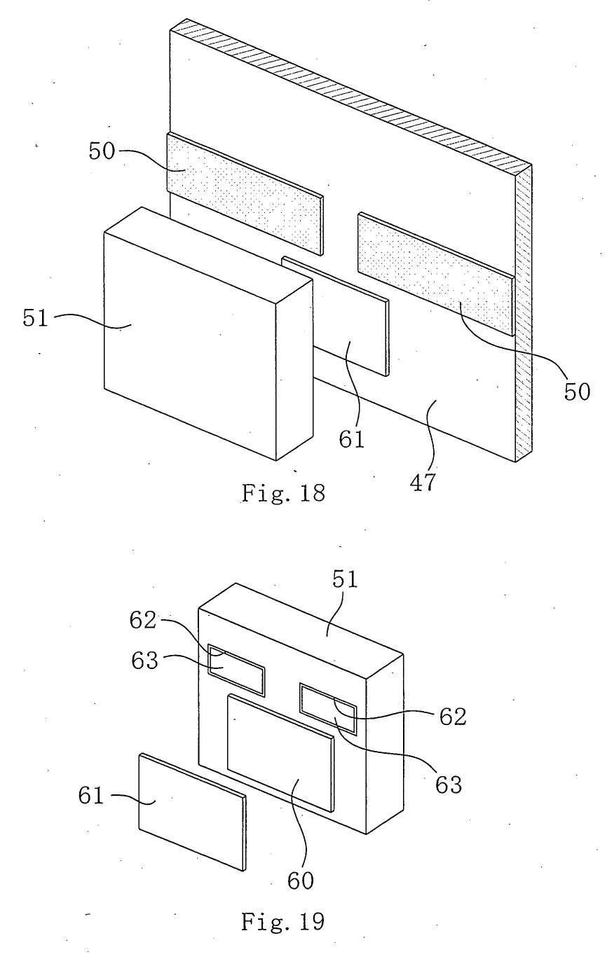

Next, the operation of installing the detector 51 on the glass plate 47 on which the conductive pattern 50 is formed, will be described. As shown in FIG. 18-FIG. 20, the detector 51 is housed in a flat, parallelepiped-shaped casing. A fixing tab 60 is formed on its rear side which is its contact side with the glass plate 47, the detector 51 being fixed to the surface of the glass plate 47 by this fixing tab 60 using a double-sided adhesive tape 61. A pair of openings 62 are also formed on the rear surface of the detector 51, U-shaped spring contacts 63 which function as electrodes being arranged to these openings 52, respectively. These spring contacts 63 are connected to the conductive pattern 50.

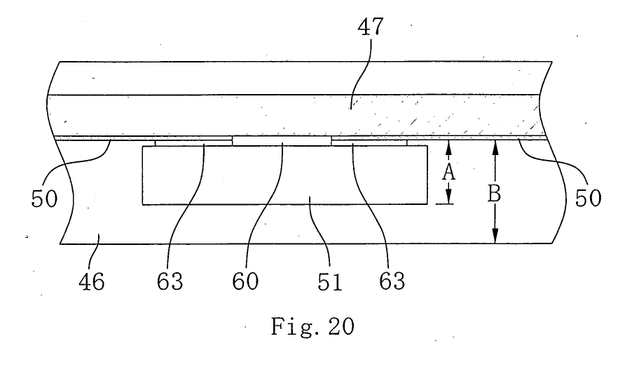

The detectors 51 are fixed to the upper edge of the conductive pattern 50 of the glass plates 47 such that they straddle the split end parts thereof. The spring contacts 63 facing the openings 60 of the detectors 51, as shown in FIG. 20, are respectively disposed in contact with the either end side of the conductive pattern 50. A detection circuit is connected to the either ends of the conductive pattern 50 via the pair of spring contacts 63.

Here, when the detector 51 is fixed to the surface of the glass plate 47, as shown in FIG. 20, a protrusion amount A of the detector 51 in the thickness direction of the glass plate 47 is less than a protrusion amount B of the frame in the same direction. In other words, A<B. This relation is maintained over the entire circumference of the window frame 46 of the glass window 45. Therefore, even if the detector 51 is fixed, it can be applied to the opening/closing type glass windows 45 without interfering with the opening/closing action of the glass windows 45.

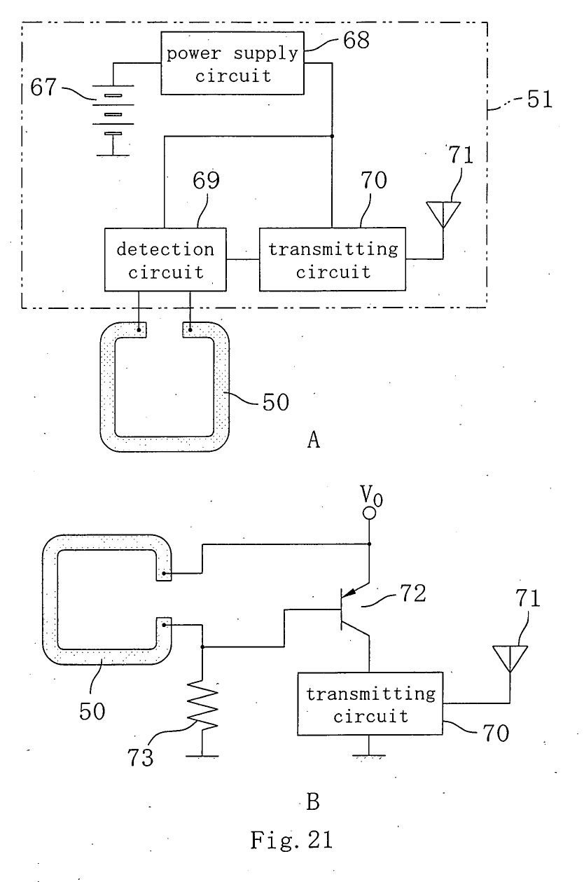

FIG. 21A shows the circuit of the detector 51. The detector 51 uses a dry battery 67 as power supply, a power supply circuit 68 being driven by this dry battery 67. The detector 51 has a detection circuit 69 and a transmitting circuit 70. Here, the detection circuit 69 detects a break in the conductive pattern 50, a pair of input terminals being connected to the both split ends of the conductive pattern 50, respectively. When the detection circuit 69 detects a break, the transmitting circuit 70 transmits a damage detection signal in response, this signal being transmitted from an antenna 71 by radio.

FIG. 21B shows a typical example of the detection circuit 69. This detection circuit comprises a pnp transistor 72 and pull-down resistor 73. The conductive pattern 50 is connected between the power supply terminals and the base of the transistor 72, the base of the transistor being grounded via the pull-down resistor 73. In other words, the base of the transistor 72 is connected to a connecting point of a series circuit formed by the conductive pattern 50 and pull-down resistor 73.

Here, if the resistance of the conductive pattern 50 is very low or can be ignored, if the conductive pattern 50 is not broken, since a voltage which is substantially equal to the power supply voltage V₀ is applied to the base of the transistor 72, a cutoff state exists between the emitter and collector of the transistor 72, so the transmitting circuit 70 does not operate. On the other hand, if the conductive pattern 50 is broken, the base of the transistor 72 falls to zero potential due to the pull-down resistor 73. Consequently, the transistor 72 becomes conducting, and drives the transmitting circuit 70. Due to this, the transmitting circuit 70 transmits a damage detection signal via the antenna 71.

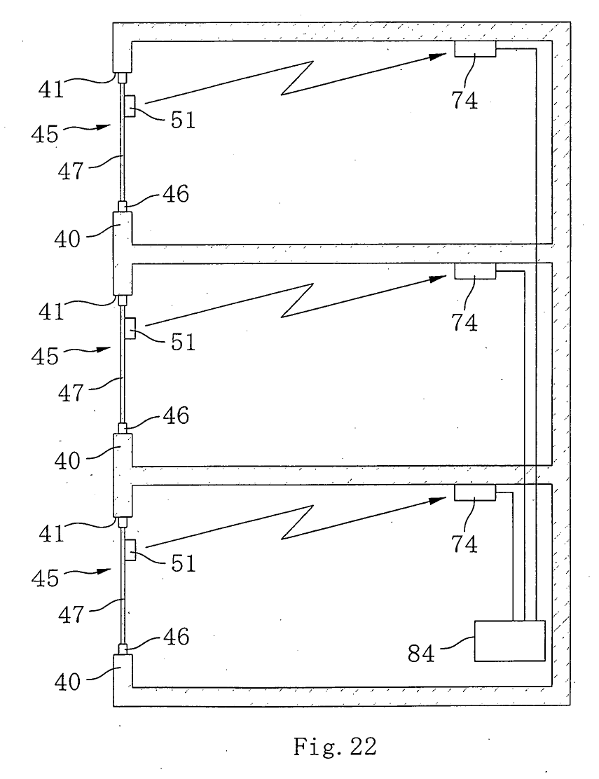

FIG. 22 shows an example of a damage detecting apparatus wherein the detectors 51 are fixed to the respective glass plates 47 of the glass windows 45. Here, the detector 51 is respectively fixed to the glass plate 47 of the glass window 45 on each floor of a building, a relay 74 also being fixed to a part of the ceiling on each floor. The relay 74 receives the damage detection signal by radio from the detector 51 fixed to the glass plate 47 of the glass window 45, and this damage detection signal can be transmitted also to, for example, a central monitoring unit 84 in the control room on the first floor. In this example, the damage detection signal is transmitted from the relay 74 to the central monitoring unit 84 by a wire cable, but here also it may be transmitted by radio instead of a wire cable.

As the detector 51 transmits the damage detection signal to the relay 74 by radio to report the damage, no wiring need be attached to the detector 51 fixed to the glass plate 47. Therefore, the detector 51 can be installed simply by fixing it to the surface of the glass plate 47, specifically on the two split end parts of the conductive pattern 50, by means of the double-sided adhesive tape 61. Installation is therefore very easy, and no additional installation work is required.

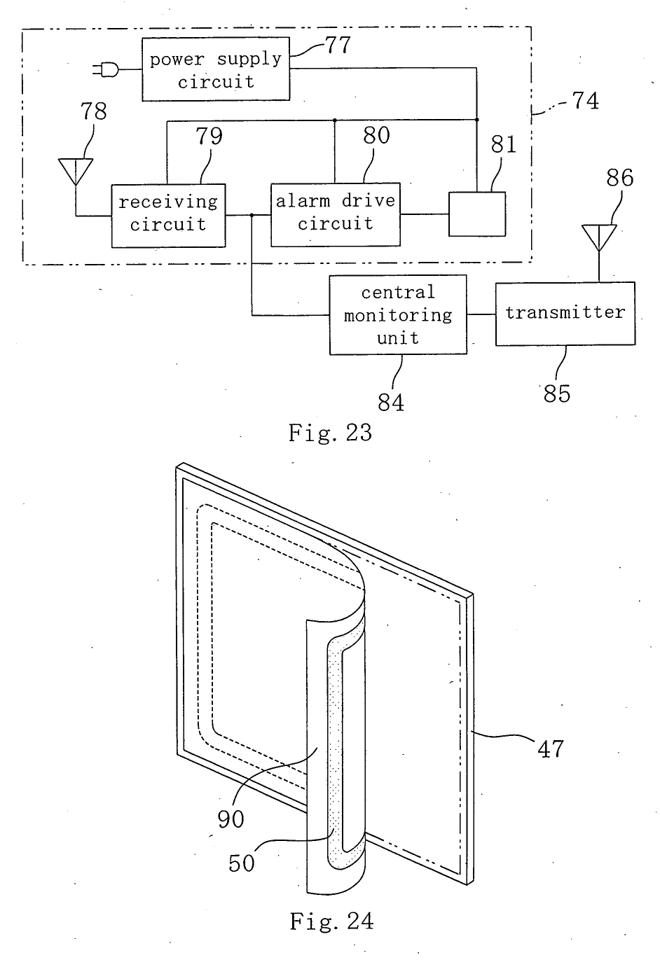

FIG. 23 shows the circuits of the relay 74 and central monitoring unit 84. The relay 74 has a power supply circuit 77. The power supply circuit 77 may be driven by for example a commercial power supply. The relay 74 has a receiving circuit 79 to which an antenna 78 is connected, the damage detection signal from the detector 51 being received, by this receiving circuit 79 by radio. An alarm drive circuit 80 is connected to this receiving circuit 79, an alarm device 81 being connected to the alarm drive circuit 80. The receiving circuit 79 is connected by a signal cable to the central monitoring unit 84 installed in the control room on the first floor. The central monitoring unit 84 is further provided with a transmitter 85, this transmitter 85 transmitting the damage detection signal to the outside from an antenna 86.

If therefore the glass plate 47 of the glass window 45 on any floor is broken for some reason, and the conductive pattern 50 is consequently broken, the detection circuit 69 of the detector 51 shown in FIG. 21 detects this situation. The detection circuit 69 sends a damage detection signal to the transmitting circuit 70. The transmitting circuit 70 transmits the damage detection signal to the relay 74 by radio via the antenna 71. The receiving circuit 79 of the relay 74 receives the damage detection signal via the antenna 78, and synchronously activates the alarm device 81 via the alarm drive circuit 80.

The receiving circuit 79 of the relay 74 sends the damage detection signal to the alarm drive circuit 80, and simultaneously transmits the damage detection signal to the central monitoring unit 84 in the control room on the first floor. Hence, the janitor of the building can be notified of the damage by the central monitoring unit 84. The central monitoring unit 84 can also transmit the damage detection signal to an external security company via the antenna 86. Here, the damage detection signal is transmitted by radio to the external organization by the transmitter 85, but the signal may likewise be conveyed from the central monitoring unit 84 to the external organization by a dedicated signal cable, telephone line or the Internet communications network. In particular, if the damage detection signal is transmitted by the transmitter 85 using the mail function of a cell telephone or PHS, the transmission costs of the system can be lowered.

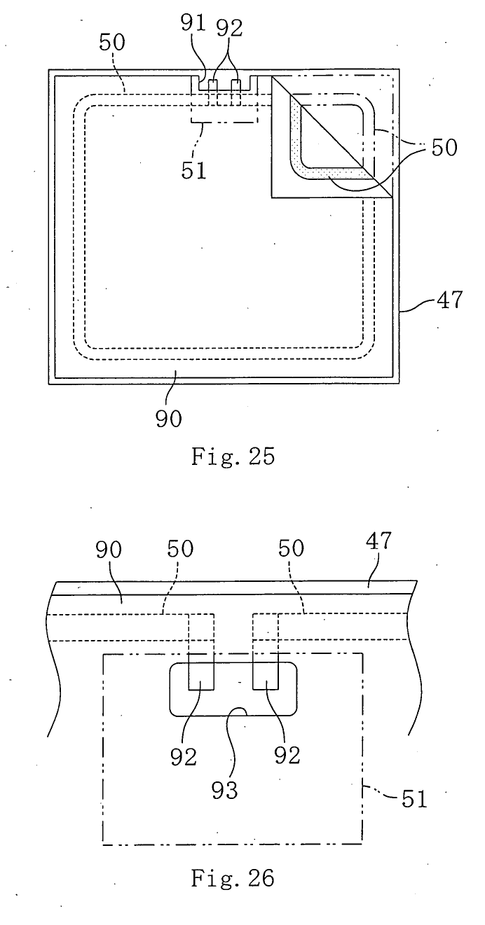

Next, referring to FIG. 25 and FIG. 26, a modification of this embodiment will be described. In the aforesaid embodiment, the conductive pattern 50 was formed directly on the surface of the glass plate 47 of the glass window 45, but instead of this construction, as shown in FIG. 24, the conductive pattern 50 may be pre-formed on a reinforcing film 90, and this reinforcing film 90 fixed to the surface of the glass plate 47. The reinforcing film 90 is preferably a transparent polymer film, which may be selected as desired from a material such as acrylic resin, polycarbonate resin or vinyl chloride resin. If a high degree of transparency is not required, a polyethylene resin such as for example polyester resin or polyethylene may be used. The thickness of this reinforcing film is preferably within the range of 50-3001 μm. The conductive pattern may be formed on the surface of the reinforcing film 90 by any desired thin film-forming method selected from among the aforesaid peeling/transfer method, chemical vapor deposition, plasma CVD or sputtering.

When this reinforcing film 90 is fixed to the glass plate 47, the conductive pattern 50 formed on the surface of the reinforcing film 90 is arranged to be in contact with the surface of the glass plate 47. As shown in FIG. 25, a notch 91 can also be formed on the upper edge side of the reinforcing film 90 above the split of the conductive pattern 50, and a pair of copper foils 92 inserted between the reinforcing film 90 and the glass plate 47 such that they are connected to the ends of the split conductive pattern 50.

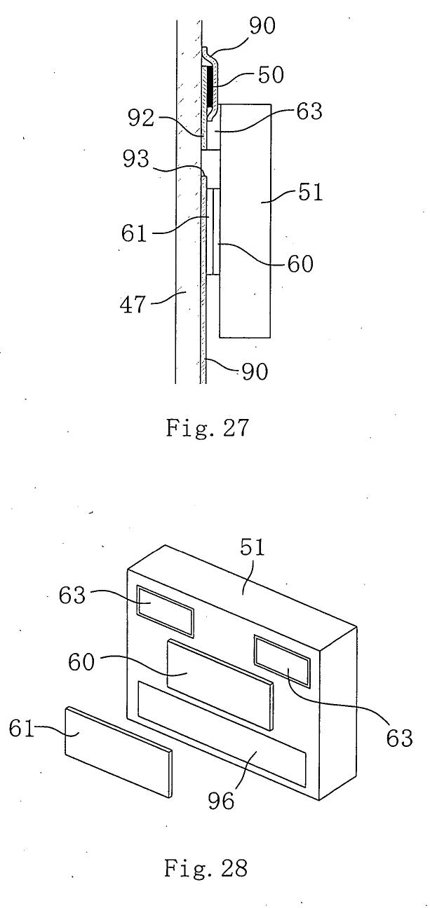

As shown in FIG. 26, instead of forming a notch 91 on the upper edge of the reinforcing film 90, an oblong opening 93 can be formed at the fixing position of the detector 51, and a pair of copper foils 92 inserted between the reinforcing film 90 and glass plate 47 such that their ends are exposed by this opening 93. Here also, the copper foils 92 are connected to the ends of the split conductive pattern 50. As shown in FIG. 27, when the detector 51 is fixed thereto, the spring contacts 63 of the detector 51 are brought in contact with the respective copper foil 92 exposed by the opening 93.

According to this construction, the glass plate 47 is reinforced by the reinforcing film 90. If the glass plate 47 breaks, fragments of the glass plate 47 are prevented from scattering by the reinforcing film 90. Moreover, if the glass plate 47 breaks, the conductive pattern 50 on the reinforcing film 90 breaks due to the excessive force, the detector 51 detects the break, and a damage detection signal is output.

Next, referring to FIG. 28, another modification will be described. In the aforesaid embodiment, as shown in FIG. 21, the power supply circuit 68 of the detector 51 was driven by for example the dry battery 67. However, in this modification, instead of the dry battery 67, the detector 51 is driven by a solar cell 96. Specifically, an oblong, rectangular solar cell 96 is exposed underneath the fixing tab 60, the power supply circuit 68 being driven by power from this solar cell 96.

When the detector 51 is fixed to the inside surface of the glass plate 47 by the double-sided adhesive tape 61, light from outside impinges on the detector through the glass plate 47, and the solar cell 96 is generated by this outside light. Therefore, the detector 51 can be used almost indefinitely without the need to replace dead batteries, as when the dry battery 67 is used.

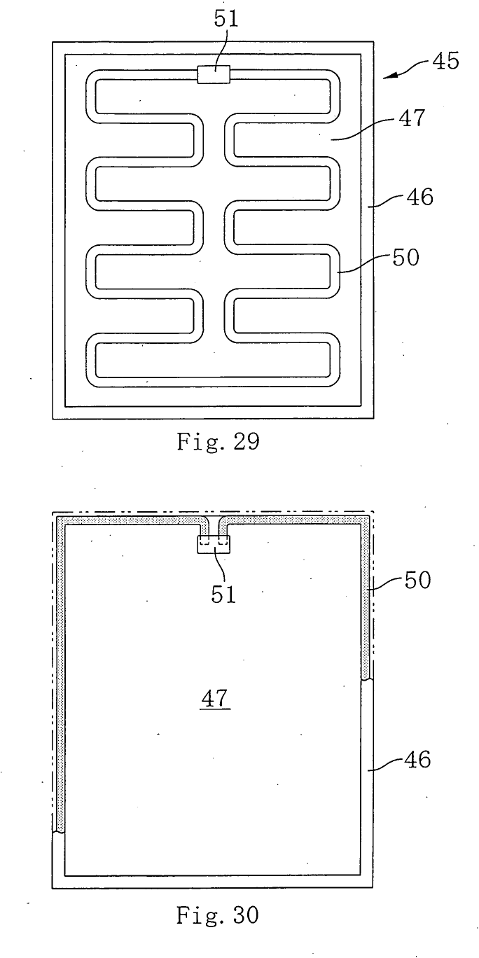

Next, a further modification will be described referring to FIG. 29. FIG. 29 shows the case where instead of the substantially rectangular shape shown in FIG. 13, the conductive pattern 50 formed on the glass plate 47 extends to the vicinity of the center of the glass plate 47, and zigzags over its whole surface. Due to this, wherever a break occurs in the glass plate 4, a break in the conductive pattern 50 cannot fail to occur.

In general, if the glass plate 47 is broken by a blow from a hammer or the like, at least one crack will reach the periphery of the glass plate 47, so damage can be detected by the shape shown in FIG. 13. However, if the glass plate 47 is cut by a glass cutter, an opening can be made essentially in the center of the glass plate 47 without a crack reaching the periphery. Moreover, if this opening does not affect the conductive pattern 50, the fact that an opening has been made with a glass cutter may not be detected. In such a case, by forming the conductive pattern 50 so that it zigzags over the whole surface of the glass plate 47 as shown in FIG. 29, even if an opening is made by a glass cutter in the center, this fact will now be detected by a break in the conductive pattern 50, so damage detection can still be performed. The pattern shown in FIG. 29 is only an example, other pattern shapes being employed as desired.

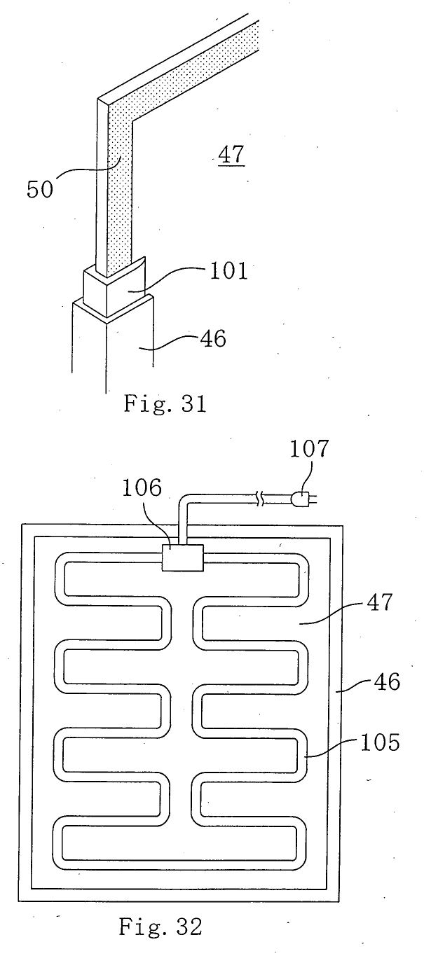

Next, referring to FIG. 30 and FIG. 31, another modification will be described. In this modification, the conductive pattern 50 is formed on the periphery of the glass plate 47 in an edge part. The conductive pattern need not be transparent or translucent provided that it has conductivity. Specifically, in this case, it may be a conductive pattern of an opaque metal film, a conducting film containing a conductive powder, an aluminum foil, a copper foil or the like. Alternatively, it may be a carbon graphite sheet obtained by forming carbon graphite into a sheet, and trimmed to a ribbon shape.

This opaque conductive pattern formed in the edge part of the glass plate 47 is insulated by shock-absorbing rubber 101 interposed between the frame 46 and glass plate 47 (FIG. 31). Detection can be performed by connecting the split or cut ends of the upper side of the conductive pattern 50 to the detector 51. According to this construction, the opaque conductive pattern 50 may be formed only in the edge part without forming a transparent or translucent conductive pattern on the surface of the glass plate 47. Hence, the conductive pattern can be formed more economically.

Next, referring to FIG. 32, another modification will be described. In this modification, a carbon graphite sheet 105 of predetermined shape is fixed to the surface of the glass plate 47 supported by the frame 46, the two cut ends of the upper side of this carbon graphite sheet 105 being connected to a detection/drive unit 106. Here, the carbon graphite sheet 105 has the dual function of a conductive pattern for damage detection, and a heating means to heat the glass plate 47.

In normal damage detection, if part of the pattern formed by the carbon graphite sheet 105 is broken, the break is detected by a detection circuit of the detection/drive unit 106. When it is desired to prevent condensation or fogging of the water on the glass plate 47, a current is passed through the carbon graphite sheet 105 by a commercial power supply via a plug 107 and the detection/drive unit 106, and the glass plate 47 is thereby warmed by Joule heat. Due to this heating action, condensation and fogging are prevented. Moreover, as a result of the heating or warming effect of this carbon graphite sheet 105, the health of the persons inside the building can be improved by a room heating effect or far infrared radiation. The carbon graphite sheet 105 is normally black, but since the surface thereof can be printed, printing can be used to give design or fashionable appeal to the window glass 47.

The invention has been described referring to specific embodiments, but it should be understood that the invention is not be construed as being limited in any way thereby, various modifications being possible within the scope and spirit of the appended claims. For example, in the aforesaid embodiments, the damage detecting apparatus which detects damage when the glass plate 47 of the glass window 45 is broken, was fitted to the window of a building, but it can also be applied to the glass door, the transparent show case, or the window glass of a vehicle or the like. Also, the shape of the conductive pattern 50 formed on the glass plate 47 can be modified in various ways as desired.

What is claimed is:

1. A damage detecting apparatus, comprising
a transparent or translucent reinforcing film having a transparent or translucent conductive pattern formed thereon, and fixed to a glass plate, and
a detector connected to said conductive pattern, wherein;
said detector performs a detection action if said glass plate is damaged and said conductive pattern is broken and goes on open circuit.

2. The damage detecting apparatus according to claim 1, wherein said glass plate is reinforced by said transparent or translucent film having said conductive pattern.

3. The damage detecting apparatus according to claim 1, wherein said conductive pattern is a transparent conductive layer.

4. The damage detecting apparatus according to claim 1, wherein said conductive pattern is made of indium oxide (In₂O₃, ITO), tin oxide (SnO₂) or zinc oxide (ZnO).

5. The damage detecting apparatus according to claim 1, wherein said conductive pattern is connected to a terminal in the vicinity of a frame.

6. The damage detecting apparatus according to claim 1, wherein said reinforcing film is fixed to said glass plate such that said conductive pattern is in contact with the surface of said glass plate.

7. A damage detecting apparatus, comprising:
a transparent or translucent conductive pattern formed on the surface of a glass plate; and
a detector having an electrode to which said pattern is connected, and which detects an open circuit of said conductive pattern in the event of breakage of said glass plate.

8. The damage detecting apparatus according to claim 7, wherein said conductive pattern is formed directly on the surface of said glass plate.

9. The damage detecting apparatus according to claim 7, wherein said conductive pattern is formed on the surface of a film fixed to said glass plate, and is in contact with the surface of said glass plate.

10. The damage detecting apparatus according to any of claim 7, wherein said conductive pattern is a transparent conductive layer.

11. The damage detecting apparatus according to claim 7, wherein said detector is fixed to the surface of the glass plate, and the dimensions of this detector in the thickness direction of the glass plate are smaller than the protrusion amount of the frame to which this glass plate is fixed, from the surface of the glass plate.

12. The damage detecting apparatus according to claim 7, wherein said detector is provided with radio transmitting means, and a damage detection signal is transmitted by radio when an open circuit of said conductive pattern is detected.

13. The damage detecting apparatus according to claim 12, comprising a relay or an alarm device provided with radio receiving means which receives the damage detection signal from said detector by radio, and said relay or alarm device transmits the damage detection signal to another control unit or sends out an alarm.

14. The damage detecting apparatus according to claim 7, wherein the drive source of said detector comprises a solar battery, and power is generated when light enters via said glass plate.

15. A damage detecting apparatus, comprising:
a conductive pattern of predetermined shape formed on the surface of a glass plate; and
a detector having an electrode to which said pattern is connected, and which detects an open circuit of said conductive pattern in the event of a breakage of said glass plate.

16. The damage detecting apparatus according to claim 15, wherein said conductive pattern is opaque, and is disposed on the edge of said glass plate so that it is hidden by a frame holding said glass plate.

17. The damage detecting apparatus according to claim 15, wherein said conductive pattern is opaque, and is a metal film, a conductive film containing a conductive powder, a metal foil or a carbon graphite sheet.

18. The damage detecting apparatus according to claim 15, wherein said conductive pattern also functions as heat generating means which warms said glass plate by Joule heat when a current is passed through it.
